(19) United States
(12) Patent Application Publication
(10) Pub. No.: US 2014/0359455 A1
(43) Pub. Date: Dec. 4, 2014

(54) METHOD AND APPRATUS TO PRESENT A CONTROL SYSTEM TOPOLOGY

(71) Applicant: GE Intelligent Platforms, Inc., Charlottesville, VA (US)

(72) Inventors: Steven William SMITH, Roanoke, VA (US); Michael Martin FRANKE, Salem, VA (US); Jack R. KIRBY, JR., Salem, VA (US)

(21) Appl. No.: 13/908,141

(22) Filed: Jun. 3, 2013

(51) Int. Cl. H04L 12/24

(52) U.S. Cl. CPC H04L 41/22
USPC 715/735

(57) ABSTRACT

Operational information concerning a plurality of devices connected in a FDT-compliant network is obtained. The operational information relates to at least one of: an operation of the plurality of devices or an interconnectivity of the plurality of devices. The operational information is uploaded to a user. The uploaded operational information is graphically presented to the user on a visual presentation medium in a way that facilitates an understanding of a structure of the FDT-compliant network. The presented information is analyzed on the visual presentation medium. Based upon the analyzing, a modification of the FDT-compliant network is selected via an interaction with the visual presentation medium, the interaction effective to create at least one DTM-compliant software instance that implements the modification.

### CROSS REFERENCES TO RELATED APPLICATIONS

Utility application entitled “Method and Apparatus for Creating Instances for Pre-defined areas of a Topology” naming as inventors Steven Smith, Michael Franke, and Jack Kirby, and having attorney docket number 267539 (130874); and

Utility application entitled “Method and Apparatus for Automatically Creating Instances from a Control System Topology” naming as inventors Steven Smith, Michael Franke, and Jack Kirby, and having attorney docket number 267013 (130873);

are being filed on the same day as the present application and are incorporated herein by reference in their entireties.

### BACKGROUND OF THE INVENTION

1. Field of the Invention

The present invention generally relates to control systems and, more specifically, to configuring control systems.

2. Brief Description of the Related Art

Field Device Tool (FDT) applications provide various types of interfaces between devices (e.g., valves, temperature sensors, and pressure sensors) and control systems. To implement the functions in these applications, Device Type Manager (DTM) modules are utilized. For example, a particular user may utilize DTM modules that open and close valves in a manufacturing plant.

DTM modules are typically software modules and are used to configure or control the various pieces of equipment. For example, these modules may be programmed to send various uniform commands and to keep and display data in a predetermined way. Other functions may also be accomplished.

In a typical system, a gateway acts as an intermediate interface between device management applications (accessible to a user) and the actual physical or field devices (e.g., those at a manufacturing plant).

A system must be configured by a user in order for the system to be able to operate. Configuring the system accurately requires a complete knowledge of the system topology and this, in turn, requires that the field devices be scanned so that the identity of these devices included in the system can be determined.

Unfortunately, the scanning process can be time-consuming and expensive. Also, the scanning process requires actual devices be connected and sometimes does not take into account offline devices. All of the above problems have created some user frustration with previous approaches.

### BRIEF DESCRIPTION OF THE INVENTION

Device manager applications (e.g., FDT frame applications of third parties) communicate with a gateway, which routes the messages between the device manager applications and the target field networks or devices. The gateway has knowledge of the configured system architecture in order to provide the routing service. In these regards, the gateway provides a communication DTM that enables communication between the device manager applications and the field devices. The communication DTM implements an interface that allows it to upload the configured system topology from the gateway rather than issuing scan requests to the physical devices in the system as the mechanism for auto discovery of the system topology as is normally done in conventional FDT environments.

In many of these embodiments, operational information concerning a plurality of devices connected in a FDT-compliant network is obtained. The operational information relates to one or more of an operation of the plurality of devices or an interconnectivity of the plurality of devices. The operational information is uploaded to a user. The uploaded operational information is graphically presented to the user on a visual presentation medium in a way that facilitates an understanding of a structure of the FDT-compliant network. The presented information is analyzed on the visual presentation medium. Based upon the analyzing, a modification of the FDT-compliant network is selected via an interaction with the visual presentation medium. The interaction is effective to create at least one DTM-compliant software instance that implements the modification.

In some aspects, the FDT-compliant network covers a predefined local area. In some examples, the predefined local area includes a manufacturing plant or a utility plant. Other examples are possible. In other examples, the uploading is performed by a gateway. Other devices may also be used.

In other aspects, the modification is an addition of a device. In still other aspects, the modification is a removal of a device.

The visual presentation medium may be deployed on or at any number of devices. For example, the visual presentation medium may be a personal computer, a lap top, a cellular phone, or a personal digital assistant. Other examples are possible.

In others of these embodiments, an apparatus that is configured to create device type manager (DTM)-compliant instances in a Field Device Tool (FDT)-compliant network includes a device manager gateway and a communication DTM. The communication DTM is configured to receive input operational information remotely loaded from the device manager gateway. The operational information concerns a plurality of devices connected in a FDT-compliant network. The operational information relates to at least one of: an operation of the plurality of devices or an interconnectivity of the plurality of devices.

The device manager gateway is coupled to the communication DTM and the communication DTM is configured to graphically present the uploaded operational information to the user on a visual presentation medium coupled to the output in a way that facilitates an understanding of a structure of the FDT-compliant network. The communication DTM is further configured to receive a selected modification of the FDT-compliant network at the input. The communication DTM is configured to create at least one DTM-compliant software instance that implements the modification.

### BRIEF DESCRIPTION OF THE DRAWINGS

FIGS. 1A and 1B together comprise a block diagram of a system for providing a control system topology according to various embodiments of the present invention, in which point A of each drawing comprises a connection between the components illustrated in each drawing figure;

FIG. 2 comprises a flow chart of an approach for providing a control system topology according to various embodiments of the present invention;

FIG. 3 comprises a block diagram of an apparatus for providing a control system topology according to various embodiments of the present invention; and

FIG. 4 comprises a screen shot showing a topology presentation according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the present approaches, a user manually builds the system from the communication DTMs, gateway DTMs, and device DTMs during system configuration without having to access to the physical hardware. For instance, a gateway knows the system topology of remotely located equipment or devices and makes that information available to device manager gateway communication DTMs hosted by the FDT Frame Application so that the system topology can be uploaded without the physical devices being connected, online or being scanned. This physical topology can be displayed to the user in the communication DTM user interface in order to facilitate manual configuration of the system, and this information can be used by a communication DTM to discover the devices as an alternative to scanning the devices directly.

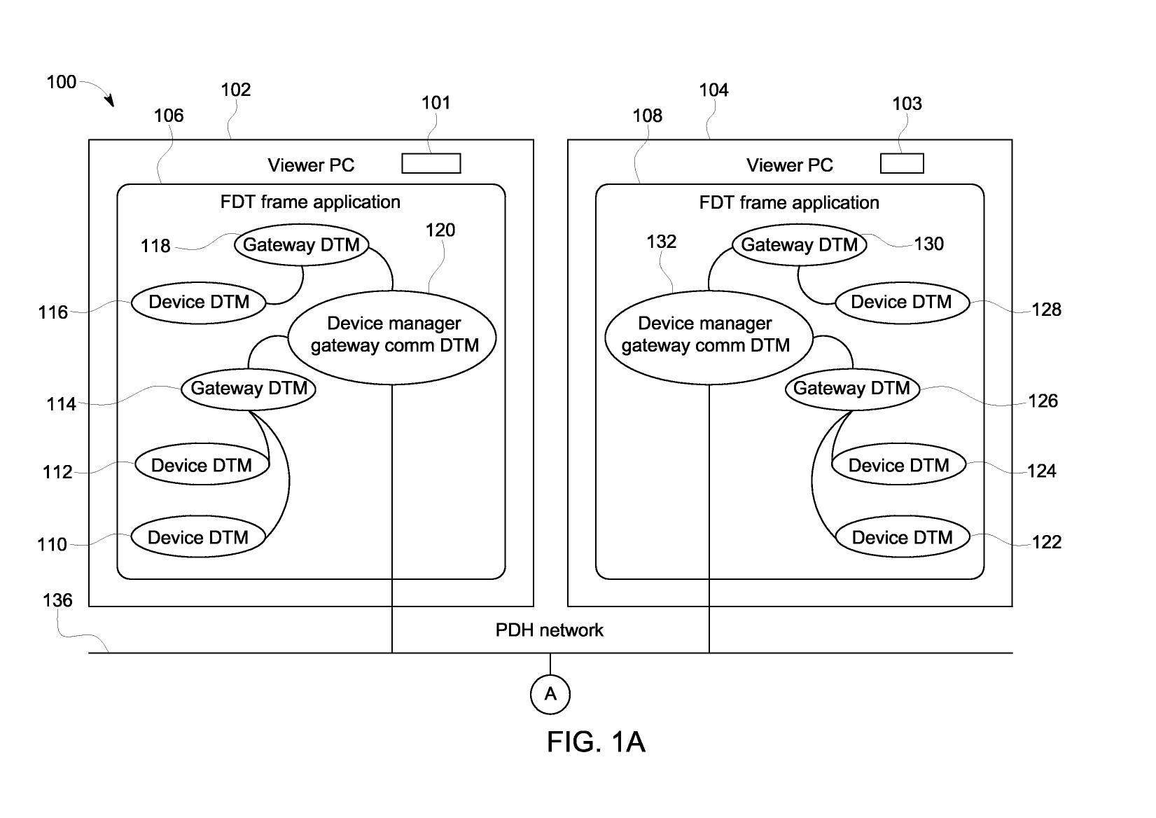

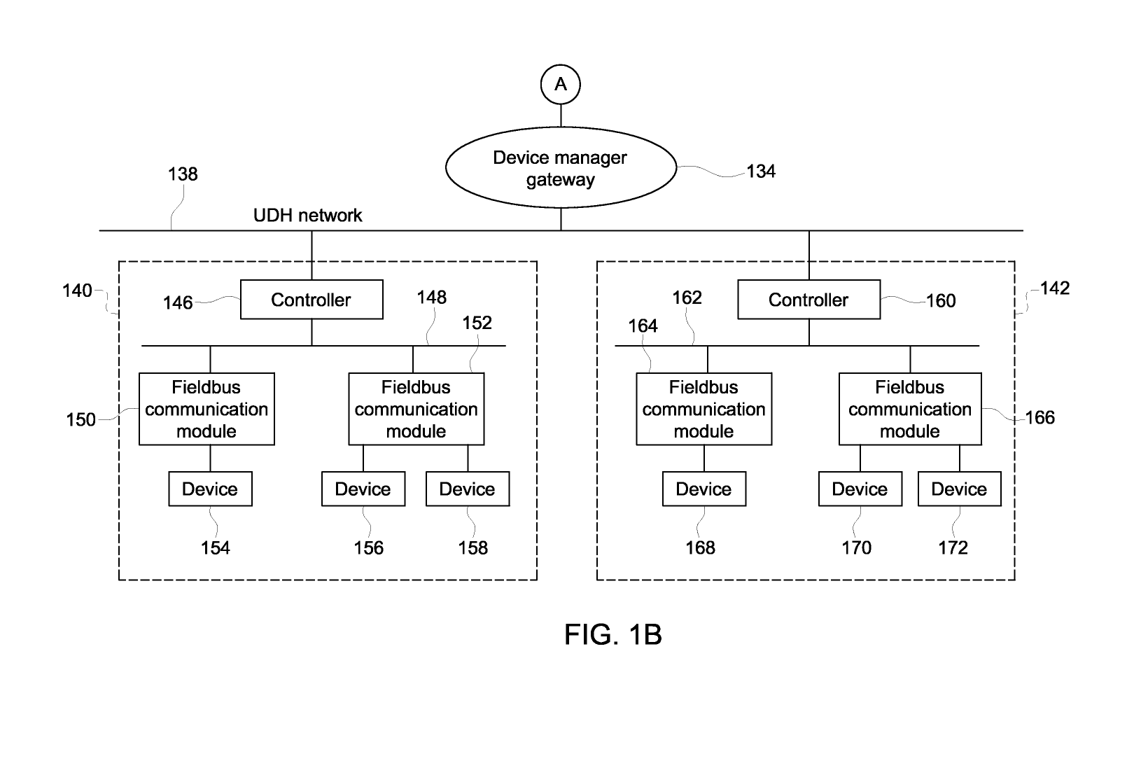

Referring now to FIGS. 1A and 1B, one example of a system 100 that is configured to provide a control system topology to a communication DTM (or some other entity) is described. The system 100 includes a first viewer personal computer 102 and a second viewer personal computer 104. The first viewer personal computer 102 and the second viewer personal computer 104 are any type of user interface device such as a personal computer, laptop, cellular phone, personal digital assistant, or any other device having a processor, memory and that is capable of displaying information in any format to a user.

It will be appreciated that the modules and functions described herein can be implemented as programmed software operating on a general purpose programming device such as a microprocessor. However, any combination of computer hardware and/or programmed computer software may be utilized to implement these functions and modules.

The first viewer personal computer 102 includes a first FDT frame application 106. The first FDT frame application 106 includes a first gateway DTM 118, a second gateway DTM 114, a first device manager gateway communication DTM module 120, a first device DTM module 116, a second device DTM module 112, and a third device DTM module 110. The second viewer personal computer 104 includes a second FDT frame application 108. The second FDT frame application 108 includes a third gateway DTM module 130, a fourth gateway DTM module 126, a second device manager gateway communication DTM module 132, a fourth device DTM module 128, a fifth device DTM module 124 and a sixth device DTM module 122.

A plant data highway (PDH) network 136 couples to a device manager gateway 134. The device manager gateway 134 couples to a first local network 140 and a second local network 142 via a unit data highway (UDH) network 138. The plant data highway (PDH) network 136 and unit data highway (UDH) network 138 operate according to established protocols as known to those skilled in the art and these will not be discussed further herein. Other examples and types of networks may also be used.

The first local network 140 includes a first controller 146 that is coupled to a first field bus communication module 150 and a second field bus communication module 152 via a local network 148. A first device 154 couples to the first field bus communication module 150. A second device 156 and a third device 158 couples to the second field bus communication module 152.

The second local network 142 includes a second controller 160 that is coupled to a third field bus communication module 164 and a fourth field bus communication module 166 via a local network 142. A fourth device 168 couples to the third field bus communication module 164. A fifth device 170 and a sixth device 172 couples to the fourth field bus communication module 166.

The DTM modules 110, 112, 116, 122, 124, and 128 are software modules that know how to contact a particular piece of equipment 154, 156, 158, 168, 170, or 172. The modules 110, 112, 116, 122, 124, and 128 know the device's parameters and automatically include functionality to create messages to obtain or change information that are specific to a particular piece of equipment.

The Gateway DTM 114 and the gateway DTM are 118 are I/O modules that communicate with the DTM equipment module in its native format and forward the messages/communications between the equipment modules and the Device manager gateway communication module 120 or 132.

The Device manager gateway communication DTM 120 and 132 make connections and exchange communications with the Device gateway manager at a remote location, e.g., a plant.

The first viewer personal computer 102 or the second viewer personal computer 104 shows the information in an appropriate format. This may be located at a personal computer to take one example.

The Device gateway manager 134 is located at a remote location, e.g., a plant. It knows the routing of messages to and from the particular pieces of equipment and which DTM to send the message to if received from the equipment. The controllers 146 and 160 pass messages to the field bus communications modules 150, 152, 164, and 166 and may be implemented as processors executing programmed computer software.

The field bus communication module 150, 152, 164, and 166 provides input/output (i/o) functions (e.g., transmitting and receiving information) with respect to the equipment or devices 154, 156, 158, 168, 170, and 172. The equipment 154, 156, 158, 168, 170, and 172 may be valves or sensors to mention two examples. Other examples of equipment may also be used.

In one example of the operation of the system of FIGS. 1A and 1B, operational information concerning a plurality of devices connected in a FDT-compliant network (e.g., the UDH network 138 and the devices coupled to it) is obtained. The operational information relates to one or more of an operation of the plurality of equipment 154, 156, 158, 168, 170, and 172 or an interconnectivity of the plurality of equipment 154, 156, 158, 168, 170, and 172. The operational information is uploaded to a user via the device manager gateway 134 and PDH network 136. The uploaded operational information is graphically presented to the user on a visual presentation medium 101 or 103 (e.g., a screen) in a way that facilitates an understanding of a structure of the FDT-compliant network. The presented information is analyzed on the visual presentation medium 101 and/or 103. Based upon the analyzing, a modification of the FDT-compliant network is selected via an interaction with the visual presentation medium 101 and/or 103. The interaction is effective to create at least one DTM-compliant software instance that implements the modification.

In some aspects, the FDT-compliant network (e.g., the UDH network 138 and the devices coupled to it) covers a predefined local area. In some examples, the predefined local area includes a manufacturing plant or a utility plant. In other examples, the uploading is performed by a gateway.

In other aspects, the modification made by the user is an addition of a device. In still other aspects, the modification is a removal of a device.

The visual presentation medium 101 and 103 may be deployed on any number of devices. For example, the visual presentation medium may be a personal computer, a lap top, a cellular phone, or a personal digital assistant. Other examples of devices are possible.

Consequently, information concerning DTM modules that should be added by a user is provided to the user. In so doing, the user's FDT frame application reflects the actual physical system topology. As a result, the user can communicate with the devices controlled by the DTM modules. It will be appreciated that standard techniques known to those skilled in the art can be used to actually add the DTM modules to the FDT frame application of the user.

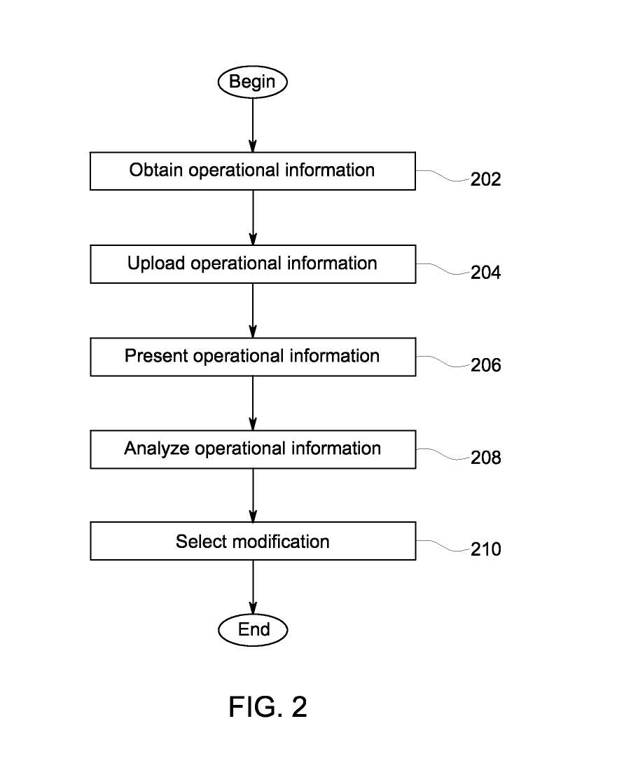

Referring now to FIG. 2, an approach for adding DTM modules to a FDT frame application is described. At step 202, operational information concerning a plurality of devices connected in a FDT-compliant network is obtained. The operational information relates to one or more of an operation of the plurality of devices or the interconnectivity of the plurality of devices. At step 204, the operational information is uploaded to a user.

At step 206, the uploaded operational information is graphically presented to the user on a visual presentation medium in a way that facilitates an understanding of a structure of the FDT-compliant network. In these regards, a list of elements to be added may be presented to the user. The list may somehow highlight the elements to be added. This may be of particular importance when the list is a long listing.

At step 208, the presented information is analyzed on the visual presentation medium (e.g., a screen). The visual presentation medium (e.g., elements 101 and 103 in FIG. 1A) may be deployed on any number of devices. For example, the visual presentation medium may be a personal computer, a lap top, a cellular phone, or a personal digital assistant. Other examples are possible. At step 210 and based upon the analyzing, a modification of the FDT-compliant network is selected via an interaction with the visual presentation medium. For example, a user selects a device to add or a device to remove. The interaction is effective to create at least one DTM-compliant software instance that implements the modification. In this way, a user at the FDT frame application can communicate with the devices at the remote location.

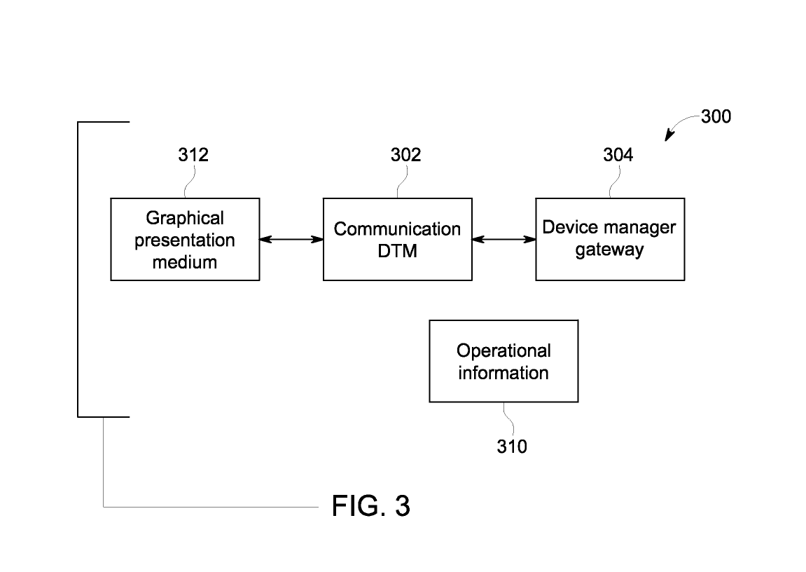

Referring now to FIG. 3, an apparatus 300 that is configured to create device type manager (DTM)-compliant instances in a Field Device Tool (FDT)-compliant network includes an communication DTM 302 and a device manager gateway 304. The communication DTM 302 is configured to receive operational information 310 remotely loaded from the device manager gateway 304. The operational information 310 concerns a plurality of devices connected in a FDT-compliant network. The operational information 310 relates to one or more of an operation of the plurality of devices or the interconnectivity status of the plurality of devices.

The device manager gateway 304 is coupled to the communication DTM 302. The communication DTM is configured to graphically present the uploaded operational information to the user on a visual presentation medium 312 coupled to its output in a way that facilitates an understanding of a structure of the FDT-compliant network. The visual presentation medium 312 may be, for examples, a graphical screen that is configured to present graphical information to a user. The device manager gateway 304 is further configured to receive a selected modification of the FDT-compliant network at its input and to create at least one DTM-compliant software instance that implements the modification according to standard FDT approaches.

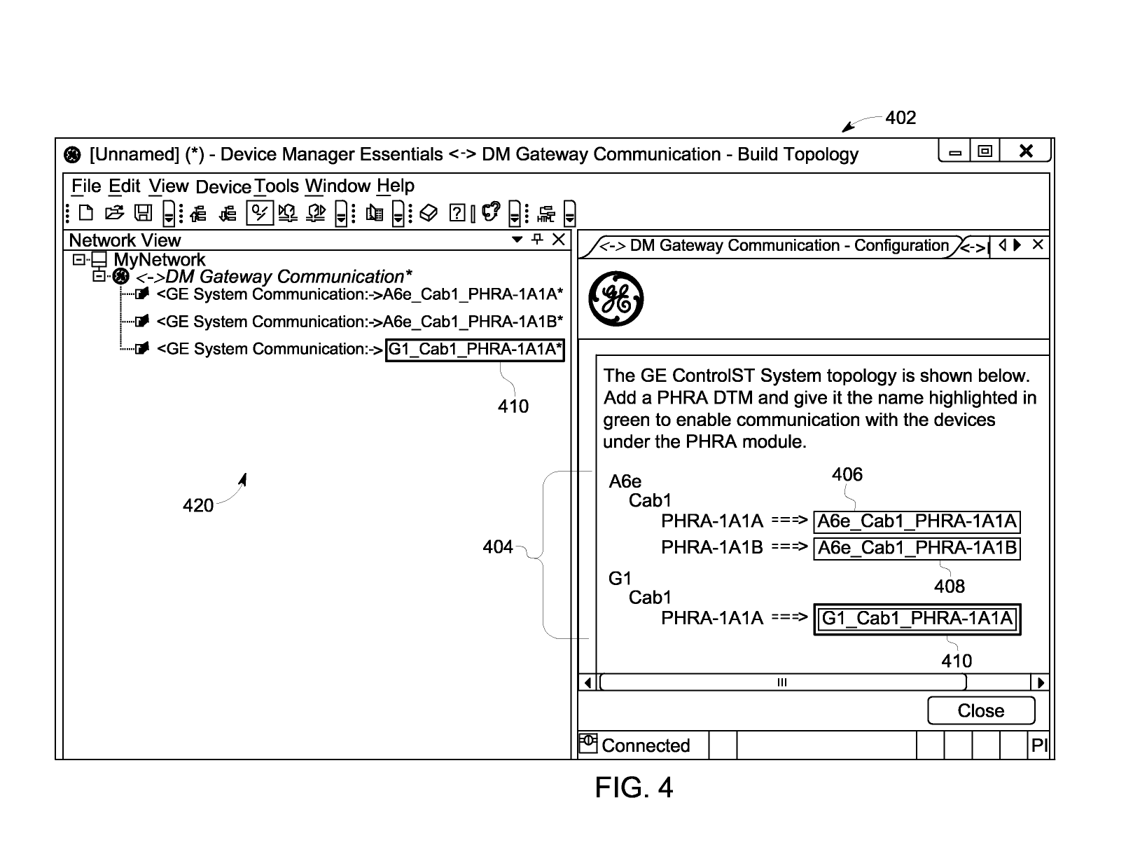

Referring now to FIG. 4, one example of the screens seen on a presentation medium are shown. In one example, the user manually adds a communication DTM, goes online with a Device Manager Gateway service running in a control system, uploads the topology information and displays it to the user in a way that they can manually add the I/O module DTMs so that they can begin communicating with the devices under these modules.

For example, a first screen 402 is presented to the user and this shows a topology 404. The topology 404 is structured as a list (e.g., structured or shown as a tree) with DTM modules 406, 408, and 410. In this case, the screen 402 presents a message for the user to add a DTM module 410, which can be manually added by a user on a second screen 420. As shown on the second screen 420, the user has manually added the DTM modules 410. Consequently, the user can begin communicating with the devices under (controlled by) the DTM module 410.

Also, the names that should be used when configuring a Frame Application project that enables communications with remotely located devices in a control system are names that reflect the topology of the control system. In this way, users can associate device DTMs hosted in the frame application with the physical devices in the control system and thereby ensure communication with these devices.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for creating device type manager (DTM)-compliant instances in a Field Device Tool (FDT)-compliant network, the method comprising:
obtaining operational information concerning a plurality of devices connected in a FDT-compliant network, the operational information relating to at least one of: an operation of the plurality of devices or an interconnectivity of the plurality of devices;
uploading the operational information to a user;
graphically presenting the uploaded operational information to the user on a visual presentation medium in a way that facilitates an understanding of a structure of the FDT-compliant network;
analyzing the presented information on the visual presentation medium; and
based upon the analyzing, selecting a modification of the FDT-compliant network via an interaction with the visual presentation medium, the interaction effective to create at least one DTM-compliant software instance that implements the modification.

2. The method of claim 1 wherein the FDT-compliant network covers a predefined local area.

3. The method of claim 2 wherein the predefined local area comprises a manufacturing plant or a utility plant.

4. The method of claim 1 wherein the uploading is performed by a gateway.

5. The method of claim 1 wherein the modification comprises an addition of a device.

6. The method of claim 1 wherein the modification comprises a removal of a device.

7. The method of claim 1 wherein the visual presentation medium is a device selected from the group consisting of a personal computer, a lap top, a cellular phone, and a personal digital assistant.

8. An apparatus that is configured to create device type manager (DTM)-compliant instances in a Field Device Tool (FDT)-compliant network, the apparatus comprising:
a device manager gateway;
a communication DTM having an input and an output, the communication DTM configured to receive input operational information remotely loaded from the device manager gateway, the operational information concerning a plurality of devices connected in a FDT-compliant network, the operational information relating to at least one of: an operation of the plurality of devices or an interconnectivity of the plurality of devices; and
wherein the device manager gateway is coupled to the communication DTM and the communication DTM is configured to graphically present the uploaded operational information to the user on a visual presentation medium coupled to the output in a way that facilitates an understanding of a structure of the FDT-compliant network, the communication DTM further configured to receive a selected modification of the FDT-compliant network at the input, the communication DTM configured to create at least one DTM-compliant software instance that implements the modification.

9. The apparatus of claim 8 wherein the FDT-compliant network covers a predefined local area.

10. The apparatus of claim 9 wherein the predefined local area comprises a manufacturing plant or a utility plant.

11. The apparatus of claim 8 wherein the modification comprises an addition of a device.

12. The apparatus of claim 8 wherein the modification comprises a removal of a device.

13. The apparatus of claim 8 wherein the visual presentation medium is a device selected from the group consisting of a personal computer, a lap top, a cellular phone, and a personal digital assistant.
